(19) United States
(12) Patent Application Publication
(10) Pub. No.: US 2025/0341339 A1
(43) Pub. Date: Nov. 6, 2025

(54) INTEGRATED ELECTRIC WATER HEATER

(71) Applicant: ADEMCO INC., Golden Valley, MN (US)

(72) Inventor: Rolf L. Strand, Crystal, MN (US)

(73) Assignee: RESIDEO LLC, Golden Valley, MN (US)

(21) Appl. No.: 19/144,618

(22) PCT Filed: Dec. 29, 2023
(86) PCT No.: PCT/US2023/086346

§ 371 Date: Jun. 30, 2025

Related U.S. Application Data
(60) Provisional application No. 63/478,085, filed on Dec. 30, 2022.

(51) Int. Cl. F24H 1/20; F24H 15/175; F24H 15/223; F24H 15/37; F24H 15/407

(52) U.S. Cl. CPC F24H 1/201; F24H 15/175; F24H 15/223; F24H 15/37; F24H 15/407

(57) ABSTRACT

Disclosed is a novel configuration and implementation of an electric hot water heater (WH). The disclosed electric WH is configured with the relays being separate from the control board, and configured with the heating element(s) of the WH, which can be electrically connected to the control board via an optoisolator. The disclosed integration of the relay off the control board and its integration into the heating element(s) reduces the load the control board must handle, thereby reducing the costs of the control board, while improving the overall operation and reliance of the electric WH and its control board. Accordingly, low current signals can be routed to the control board via the relay, thereby eliminating the need for the control board to handle high currents. Moreover, the disclosed configuration can enable the isolation of the line voltage from the control board via the optoisolator.

### CROSS-REFERENCE TO RELATED APPLICATION

This application claims the benefit of, and priority to, U.S. Provisional Patent Application No. 63/478,085, filed Dec. 30, 2022, its entirety of which is incorporated herein by reference.

### FIELD OF THE DISCLOSURE

The present disclosure is generally related to a hot water heating system, and more particularly, to a water heater with a water heater element with an integrated switching means.

### BACKGROUND

A water heater (WH) is an appliance that includes a water storage tank that heats water with high-voltage heating elements that run, in most cases, horizontally through the tank. For electric water heaters, water is heated starting at the active heating element and circulates upward from the heating element via convection.

### SUMMARY OF THE DISCLOSURE

WHs can be interchangeably referred to as storage water heaters or hot water systems (HWS), in that they are collectively understood to be a water heating appliance that uses a water storage tank (e.g., a hot water storage tank) to maximize water heating capacity and provide delivery of hot water.

Conventional storage water heaters use a variety of “fuels” to heat the storage tank. Such fuels can include natural gas, propane, fuel oil, solar energy and electricity. For purposes of this disclosure, electric water heaters will be discussed as the basis for the disclosed systems and methods, thereby evidencing a novel configuration and improved functionality for such electric water heaters. However, one of ordinary skill in the art would readily understand that the disclosed configurations and mechanisms for the disclosed electric water heaters can be applied and/or utilized for other types of water heaters without departing from the scope of the instant disclosure.

By way of background, conventional control of electric water heaters makes use of high current snap-acting temperature sensitive switches mounted to the surface of the tank. Newer electric water heaters are starting to use high current relays as the switching means to increase functionality. Traditionally, as with most if not all relay controlled electric water heaters, the relays are configured as part of and/or incorporated within the electric water heaters' control boards. However, using the relays on control boards requires the design and implementation of the control board to be able to handle large current connections and traces. This can lead to high cost control boards. That is, not only is the cost to create such control boards increased, but the mechanisms for implementing such control boards has drawbacks, which can include, but are not limited to, increased costs to run the electric WH as well as faulty WH due to the high loads the control board must consistently manage. Thus, high costs and unreliable operation can be evidenced from conventional electric WHs.

The disclosed systems and methods address these shortcomings, among others, by providing a novel configuration and implementation of the switching means and the control board. As discussed in more detail below, rather than including the relay as part of the control board, as in conventional electric WHs, the disclosed electric WH is configured with the switching means being separate (however still connected, as discussed below) to the control board. In some embodiments, as discussed below, the switching means can be configured as integrated with the heating elements, which are electrically connected to the control board. According to some embodiments, the disclosed integration of the switching means off the control board and its integration into the heating element(s) reduces the load the control board must handle, thereby reducing the costs of the control board, while improving the overall operation and reliance of the electric WH and its control board.

According to some embodiments, the disclosed configuration and implementation can involve the switching means control lines being available at a small connector on a heating element spud. This can allow the dissipated heat from the switching means to flow into the tank (and water) via the spud mounting lug. Therefore, low current signals can be routed to the control board, thereby eliminating the need for the control board to handle high currents. Moreover, disclosed configuration of the switching means integration into the heating element(s) can isolate the line voltage from the control board, which in some embodiments, can be provided via a coupler being integrated with the heating element(s).

In some embodiments, the coupler can be an optoisolator (also known as an optical coupler, photocoupler or optocoupler), which is a semiconductor device that transfers an electrical signal between isolated circuits (e.g., the heating element and the control board, for example). Indeed, among other benefits, the optoisolator can aide in the prevention of the control board being subject to voltage surges, thereby ensuring its operational integrity.

Thus, in addition to the avoidance of the control board handling high currents, the disclosed configuration and implementation reduces the loads the control board must handle, thereby improving its operational efficiency, reliability, durability and accuracy.

According to some embodiments, as discussed in more detail below, the switching means can be an electromagnetic relay or any type of known or to be known solid state switch, which can include, but not be limited to, a triode for alternating current (TRIAC, or bidirectional or bilateral triode thyristor), an insulated-gate bipolar transistor (IGBT), metal-oxide semiconductor field-effect transistor (MOSFET, and the like, or some combination thereof. In some embodiments, the disclosure herein will reference a TRIAC; however, it should not be construed as limiting, as one of ordinary skill in the art would understand that other types of solid-state switches/relays can be implemented without departing from the scope of the instant disclosure.

According to some embodiments, a method is disclosed for operating a water heater element with an integrated switching means. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed cause at least one processor to perform a method for operating a water heater element with an integrated switching means.

In accordance with one or more embodiments, an apparatus (or system) for a water heater element with an integrated switching means is provided that includes one or more processors and/or device components configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTIONS OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is an example depiction of an exemplary hot water heater according to some embodiments of the present disclosure;

FIG. 2 is a block diagram of an example configuration of a hot water heater according to some embodiments of the present disclosure;

FIG. 3 is a block diagram illustrating components of an exemplary controller of a hot water heater according to some embodiments of the present disclosure; and

FIG. 4 illustrates an exemplary work flow according to some embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

Certain embodiments and principles will be discussed in more detail with reference to the figures. According to some embodiments, as discussed herein, disclosed is an apparatus appliance (a system of an electric WH) that provides a novel configuration and implementation, as discussed herein. According to some embodiments, the disclosed electric WH is configured with a switching means (e.g., a solid-state switch, such as a TRIAC) being separate from the control board, and integrated with the heating element(s) of the WH, which can be electrically connected to the control board via an optoisolator.

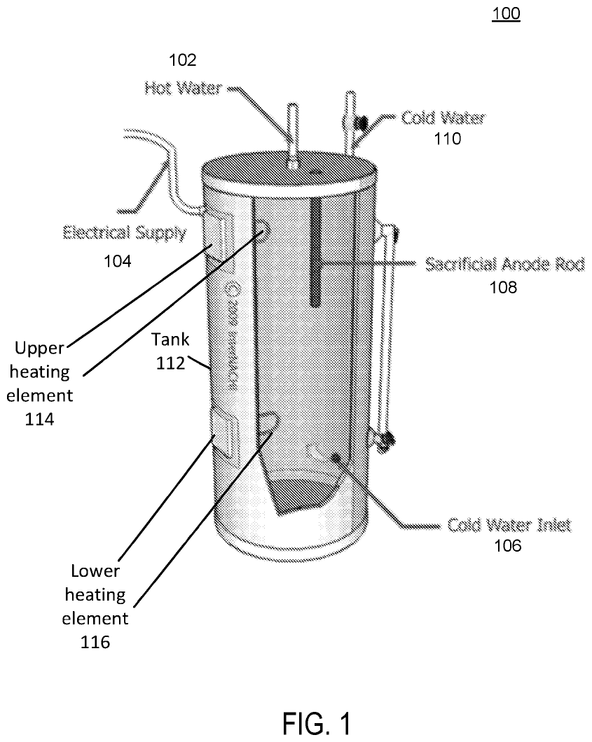

With reference to FIG. 1, depicted is an exemplary electric WH 100. According to some embodiments, electric WH can include, but is not limited to, hot water outlet 102 (e.g., referred to as “hot water” in FIG. 1), electrical supply 104, cold water inlet 106, sacrificial anode rode 108, cold water outlet 110 (e.g., referred to as “cold water” in FIG. 1), tank 112, upper heating element 114 and lower heating element 116. One of skill in the art would understand that an electric WH 100 can include additional and/or fewer parts/components, and such disclosure is provided to evidence the understood operation of an electric WH. For example, a shut-off value (not shown), inter alia, can be included, among other components for the operation of the electric WH 100.

According to some embodiments, hot water outlet 102 and cold water outlet 110 operate to provide an output of hot and cold water, respectively, to a location. Each outlet can be a pipe exiting the tank 112 of the electric WH 100 for connection to a water line at the location. For example, electric WH 100 can be installed at a location, such as a home, for example, whereby hot and cold water can be provided to the location's water fixtures (e.g., faucets, spickets, dishwashers, washing machines, and the like) via hot water outlet 102 and cold water outlet 110, respectively.

According to some embodiments, tank 112 (or the water storage tank or hot water storage tank, used interchangeably) is the component that houses water. According to some embodiments, tank 112 can include an inner shell, whereby a water protective liner can hold a volume of water (e.g., 40-60 gallons of water, for example). In some embodiments, the held water can be held at a predetermined value of pounds per square inch (PSI)—for example, 50 to 100 PSI, which can be according to a pressure range of the water system providing the water (e.g., a residential water system, for example). In some embodiments, the inner shell can be constituted of metal, and the exterior of tank 112 can be covered with an insulating material (e.g., polyurethane foam, for example). In some embodiments, tank 112 can include an outer shell, which can include an additional insulating blanket.

According to some embodiments, the tank includes upper heating element 114 and lower heating element 116. As depicted in FIG. 1, heating elements 114 and 116 are provided specific to upper and lower portions of tank 112, respectively. As understood by those of skill in the art, the lower heating element 116 can receive input cold water, which can be provided to an upper portion upon it being heated to a particular or threshold temperature value. Accordingly, the upper heating element can be utilized when the tank 112 is filled with cold water (e.g., water a temperature below a predetermined threshold value, for example) and/or when the tank 112 runs out of hot water. Accordingly, in some embodiments, each heating element 114 and 116 can have an associated thermostat to determine operating temperatures of the water in each respective portion of the tank 112 (as discussed below).

According to some embodiments, electric supply 104 (e.g., a power terminal) can correspond to a dedicated circuit for handling an input load of voltage. In some embodiments, electric supply 104 can be positioned or affixed to the exterior of tank 112. For example, a 240-volt dedicated circuit can be configured with electric WH 100. According to some embodiments, electric supply 104 is configured to handle, process and act as the intake for the power supply to the electric WH—for example, a direct current (DC) power source.

According to some embodiments, cold water inlet 106 is configured as the intake from the water system at the location. For example, a pipe running from the water supply of a home can be connected to cold water inlet 106, which provides a source of the water held in tank 112 (e.g., a lower portion, as discussed above), and heated and dispersed via the disclosed functionality, as discussed herein.

According to some embodiments, sacrificial anode rod 108 can be implemented to prevent and/or retard corrosion. In some embodiments, for example, rod 108 may be made of magnesium or aluminum with a steel core.

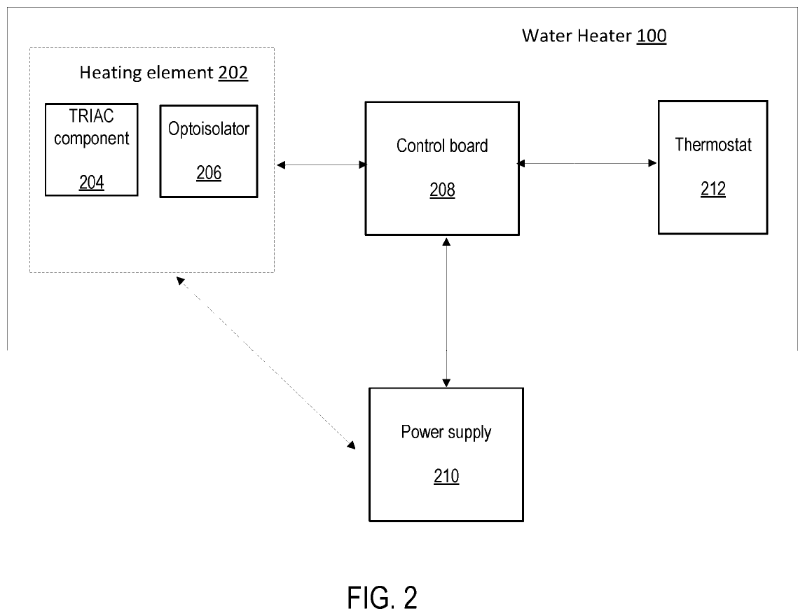

Turning to FIG. 2, depicted are non-limiting components of electric WH 100 according to some embodiments of the present disclosure. It should be understood that the components discussed herein are non-exhaustive, as additional or fewer components may be applicable and/or included in electric WH 100, as understood by those of ordinary skill in the art.

According to some embodiments, electric WH 100 can include heating element 202, control board 208, power supply 210 and thermostat 212. In some embodiments, as discussed herein, heating element 202 can include and/or be associated/integrated with, but is not limited to, a TRIAC component 204 and optoisolator 206. As depicted in FIG. 2, power source 210 can be connected to electric WH 100, as discussed below.

In some embodiments, heating element 202 can extend into an interior of the water tank 112, whereby a portion of its body at the distal end of the heating element 202 passes through at least the inner wall of the tank 112. In some embodiments, heating element 202 can include at least one flange that is configured to secure the body of the heating element 202 to the water tank 112.

According to some embodiments, as discussed below, heating element 202 can correspond to upper and lower heating elements 114 and 116 (which, as provided above, can have an associated thermostat 212, as discussed in detail below).

In some embodiments, power source 210 can provide any type of power to electric supply 104, as discussed above. For example, power supply 210 can provide alternating current (AC) or DC power at specified levels (e.g., 120V, 240V, for example). Thus, in some embodiments, electric supply 104 of FIG. 1, discussed supra, can be configured to accept both AC and DC power.

In some embodiments, for example, the provided power can be provided to control board 208. In some embodiments, as depicted in FIG. 2, as discussed above, the power provided to electric WH 100 can be routed via TRIAC components, so as to offload the current trace and voltage the control board 208 must handle (e.g., as depicted via the dashed line in FIG. 2).

Thus, for example, as discussed herein, integration of TRIAC component 204 with heating element 202 can enable the routing of low current signals to the control board, whereby the high current signals can be handled via heating element 202/TRIAC 204, thereby eliminating the need for the control board 208 to handle/process the high currents. In some embodiments, optoisolator 206, and its integration with heating element 202, can further enable the isolation of the line voltage from the control board 208. In some embodiments, optoisolator 206 may be configured as an intermediary circuit positioned between heating element 202 and control board 208 (e.g., as indicated by the dashed box line associated with heating element 202 in FIG. 2).

In some embodiments, TRIAC component 204 can correspond to a n terminal (e.g., three, for example) electric component that can conduct current in either direction when triggered. TRIACs can include a subset of thyristors, which as one of ordinary skill in art would understand, are solid-state semiconductor devices with k layers (e.g., four, for example) of alternating P- and N-type materials used for power applications. Accordingly, in some embodiments as discussed herein, TRIAC component 204 (e.g., thyristor(s)) can act as a bistable switch (or latch) that can conduct current when the gate receives a current trigger, and continue such conduction until voltage across the device is reversed biased (or until the voltage is removed, for example, at the conclusion of a duty cycle).

Accordingly, as discussed below, TRIAC component 204, which can be a solid state switch, can be associated with a power line connected to heating element 202, and can be configured to actuate power to the heating element 202 to achieve a temperature at a set point. In some embodiments, therefore, TRIAC component 204 can be integrated as part of heating element 202; and, in some embodiments, TRIAC component 204 can be positioned as a separate circuitry in an intermediary position between the heating element 202 and the control board 208 and/or power supply 210 (e.g., as indicated by the dashed box line associated with heating element 202 in FIG. 2).

According to some embodiments, as discussed above, optoisolator 206 can be a semiconductor device that transfers an electrical signal between isolated circuits (e.g., the heating element 202 and the control board 208, for example). In some embodiments, optoisolator 206 can be any type of optocoupler, photocoupler or optical isolator that enables the transfer of electric signals via light. In some embodiments, optoisolator 206 can include a light emitting diode (LED) and a phototransistor, which can transmit digital (on-off) signals as well as analog signals.

According to some embodiments, thermostat 212 can include, but is not limited to, a frame and housing, flange, spring, a wax element, and/or any other type of component associated with known or to be known thermostat devices. In some embodiments, thermostat 212 can be configured with TRIAC components and/or relay components (not shown) so as to enable a dual-mode operation for a duty cycle.

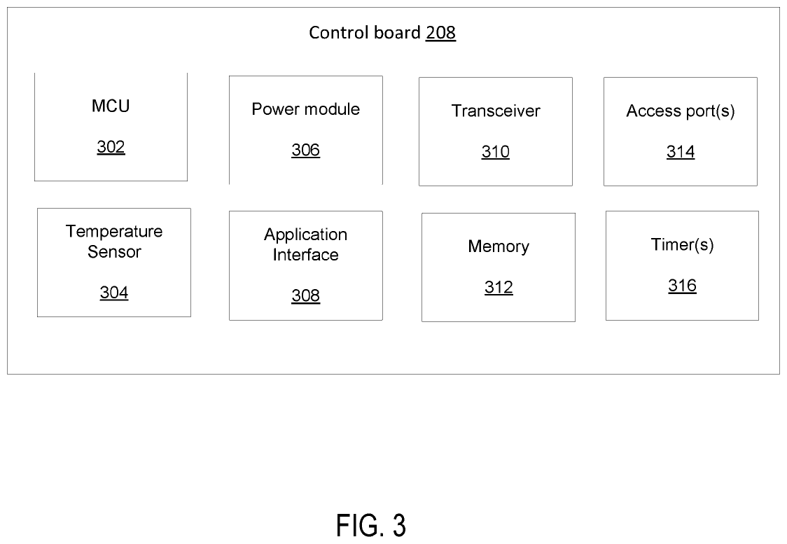

Turning to FIG. 3, in accordance with some embodiments, disclosure of non-limiting example embodiments of control board 208 is provided. It should be understood that the components discussed herein are non-exhaustive, as additional or fewer components may be applicable, as understood by those of ordinary skill in the art.

According to some embodiments, as discussed herein, control board 208 can be configured as a controller that is in communication with TRIAC component 204, in so as to control TRIAC component 204 to actuate power the heating element 202 based on the temperature set point. Further, according to some embodiments, as discussed herein, control board 208 can be configured to determine a difference between a temperature set point and a temperature of the water in the tank 112 (as provided via temperature sensor 304, discussed infra), and determine a power value and/or timing for such power for the heating element 202 (e.g., as enabled via power module 206, discussed infra).

According to some embodiments, control board 208 can include microcontroller (MCU) 302, temperature sensor 304, power module 304, application interface 308, transceiver 310, memory 312, access port(s) 314 and timer(s) 316.

According to some embodiments, MCU 302 can operate as, and/or include a processor(s) that can execute algorithms, firmware and/or software in accordance with one or more of the disclosed example embodiments.

According to some embodiments, the disclosed functionality can be executed by controller 208, via MCU 302 executing a software application. In some embodiments, the application may be stored in memory 312.

In some embodiments, the application may be a web-based application that is executed by controller 208 or a connected device (not shown), for example, user equipment (UE), such as a user's mobile device, which can be connected to and/or paired with the electric WH 100 (via controller 208 and/or thermostat 212, for example). For example, in some embodiments, UE can connect to electric WH 100 via a network, which as discussed below, can be any type of network, such as, but not limited to, a local network, wireless network, cellular network, the Internet, and the like (as discussed below). In some embodiments, UE can connect to electric WH 100 via any type of known or to be known pairing mechanism, including, but not limited to, Bluetooth™, Bluetooth Low Energy (BLE), Near Field Communication (NFC), and the like.

In some embodiments, the application may execute on the UE, whereby controls of the electric WH 100 are provided as computer-executable instructions via the paired connection to controller 208 (e.g., via transceiver 310, for example). In some embodiments, the application may be configured and/or installed as an augmenting script, program or application (e.g., a plug-in or extension) to another application or program provided by a service provider and/or executing on controller 208 and/or a UE.

By way of non-limiting example, according to some embodiments, as discussed herein. MCU 302 can operate to control how power is managed, guide components for measurements of temperatures and/or duty cycles (e.g., temperature sensor 304, power module 306, control thermostat 212, control timer 316, store data in memory 312, and the like.

According to some embodiments, temperature sensor 304 can be configured to monitor temperature, as discussed in more detail below. In some embodiments, for example, temperature sensor 304 can monitor the temperature of the water in the tank 112, and upon reaching a temperature threshold or set temperature value, enable its output via hot water outlet 102.

In some embodiments, power module 306 can enable and/or control the reception of power from power supply 210 via electric supply 104, and enable its routing and/or reception with heating element 202, as discussed herein. As discussed below, in some embodiments, power module 306 can operate to determine, or at least enable a determination of, a power value and timing of such power to provide to heating element 202 based on a current temperature and temperature set point.

In some embodiments, application interface 308 can be configured to receive and route instructions to/from MCU 302, temperature sensor 304, power module 306, transceiver 310, memory 312, access port(s) 314 and timer(s), as well as to/from heating element 202 (and TRIAC component 204 and optoisolator 206), thermostat 212 and power supply 210. For example, interface 308 may enable the input of temperature settings for the heating of the water in tank 112 via thermostat 212, which can be provided by a user, a connected UE and/or the software application being executed by MCU 302.

In some embodiments, transceiver 310 can be configured to send and/or receive electronic signals among the components of controller 208, as well as the components of the electric WH 100. For example, transceiver 310 can be utilized to effectuate communication to/from heating element 202 and controller 208, as discussed herein.

In some embodiments, memory 312 can be any type of known or to be known memory (e.g., short term or long-term, for example), and can be configured to store data related to the processing of electric WH 100 (e.g., for example, the temperature settings).

According to some embodiments, access port(s) 314 can be configured as a connection port (e.g., both electrical and/or physical) to which control signals can be provided/received by controller 208 to/from other components of electric WH 100. For example, access port(s) 314 can be a universal serial bus (USB) port, electrical outlet and/or other type of electrical connector that can receive direct signal data and/or network signal data.

According to some embodiments, timer(s) 316 can be configured to enable heating (or duty) cycles. For example, a timer 316 can provide instructions for how long a heating cycle should last, when it should start, when it should finish, and/or any other type of time period, time, date, and the like, or some combination thereof.

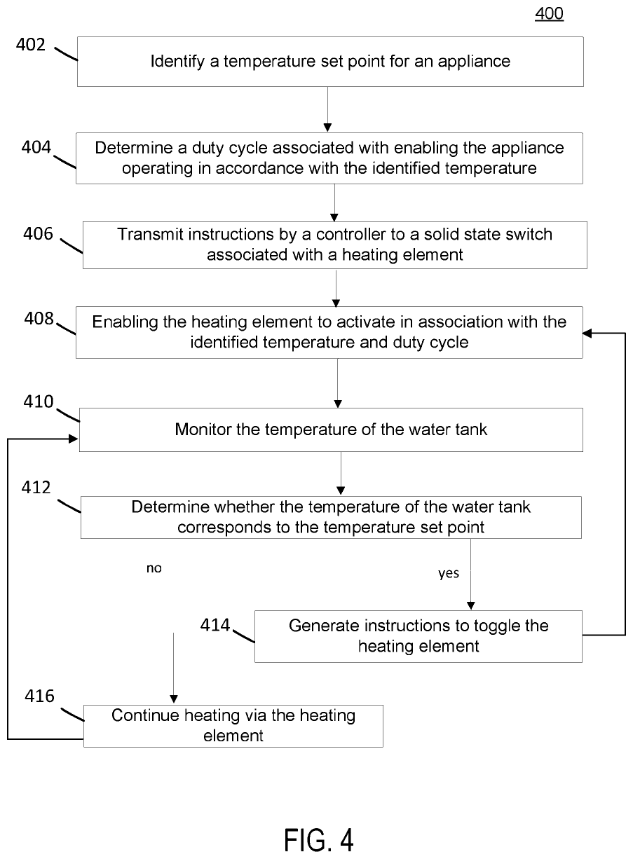

Turning to FIG. 4, provided is Process 400 which disclosed non-limiting example embodiments for executing the configurations discussed above at least in relation to FIG. 2 and FIG. 3. According to some embodiments, as discussed herein, disclosed is an apparatus appliance (a system of an electric WH) that provides a novel configuration and implementation, as discussed herein. According to some embodiments, the disclosed electric WH is configured with a switching means (e.g., a solid-state switch, such as a TRIAC) being separate from the control board, and configured as integrated with the heating element(s) of the WH, which can be electrically connected to the control board via an optoisolator. According to some embodiments, the steps of Process 400 can be effectuated via components of electric WH 100, such as, as discussed above, control board 208.

According to some embodiments. Process 400 begins with Step 402 where a temperate set point for an appliance is identified. For example, a temperature set point is a temperature at which to heat the volume of water stored in tank 112 of electric WH 100. As discussed above, the temperature set point can be input by a user, or correspond to a programmed temperature setting as indicated by timer(s) 316 and/or thermostat 212.

In Step 404, a determination is made regarding a duty cycle associated with enabling the electric WH 100 to heat the water at the identified temperature (e.g., the temperature set point). According to some embodiments, as discussed above, the duty cycle can enable an amount and applied timing of power (e.g., a 60 hertz signal or 60 times per second, for a single-phase 120V AC power supply, for example). According to some embodiments, analysis of the temperature set point can enable the determination of the duty cycle (e.g., a higher temperature set point can correspond to a higher power draw, for example).

In some embodiments, Step 404 can involve receiving a current temperature reading of the water in the tank 112 via temperature sensor 304, whereby MCU 302 can determine a difference between the current temperature and the temperature set point. Ibis determined difference can be utilized to determine the duty cycle needed to attain the temperature set point.

In Step 406, an electronic communication signal can be provided by a controller (e.g., control board 208) to a heating element (e.g., heating element 202). In some embodiments, the instructions can correspond to power provided by power supply 210, whereby heating element 202 can effectuate the heating of water in tank 112. In some embodiments, the instructions can be communicated via TRIAC component 204 and/or optoisolator 206, which can enable control of the heating element 202 (e.g., toggling the switch associated with TRIAC component 204, for example).

In Step 408, heating of the water in tank 112 is effectuated via heating element 202 based on the received instructions. Accordingly, in some embodiments, the instructions can include information and/or provide input corresponding to the set temperature point and the duty cycle. In some embodiments, for example, a power supply can be provided to heating element 202.

In Step 410, the temperature is monitored to determine when and/or if the temperature in tank 112 reaches at least a threshold range corresponding to the temperature set point. In some embodiments, the monitoring can be in accordance with the temperature reaching the exact temperature set point; and in some embodiments, the monitoring can be in accordance with the threshold range (or deviation)—for example, at least within n degrees (e.g., +/−1 degree, for example).

In some embodiments, the monitoring can be performed according to a criteria associated with a predetermined period of time, which can include or be based on, but is not limited to, a continuous monitoring or tracking, every n seconds, according to a programmed setting (e.g., heat water to X degrees for Y hours, therefore, the monitoring can occur as a proportional ratio of this timing (e.g., Y/Z minutes, for example).

In Step 412, based on the monitoring, a determination is made regarding whether the temperature of the water tank 112 corresponds to the temperature set point. In other words, in some embodiments, whether the temperature in the tank 112 is at least within the threshold range or matches the temperature set point.

According to some embodiments, the determination in Step 412 (and in some embodiments, Step 404, discussed supra) can be performed via control board 208, for example, executing and/or implementing any type of known or to be known computational analysis technique, algorithm, mechanism or technology, which can include, but is not limited to, a specific trained artificial intelligence/machine learning model (AI/ML), a particular machine learning model architecture, a particular machine learning model type (e.g., convolutional neural network (CNN), recurrent neural network (RNN), autoencoder, support vector machine (SVM), and the like), or any other suitable definition of a machine learning model or any suitable combination thereof.

In some embodiments, control board 208 may be configured to utilize one or more AI/ML techniques to perform the determination of Step 412 (and/or Step 404), such as, but not limited to, computer vision, feature vector analysis, decision trees, boosting, support-vector machines, neural networks, nearest neighbor algorithms, Naive Bayes, bagging, random forests, logistic regression, and the like.

In some embodiments and, optionally, in combination of any embodiment described above or below, a neutral network technique may be one of, without limitation, feedforward neural network, radial basis function network, recurrent neural network, convolutional network (e.g., U-net) or other suitable network. In some embodiments and, optionally, in combination with any embodiment described above or below, an implementation of Neural Network may be executed as follows:
a. define Neural Network architecture/model;
b. transfer the input data to the neural network model;
c. train the model incrementally;
d. determine the accuracy for a specific number of timesteps;
e. apply the trained model to process the newly-received input data; and
f. optionally and in parallel, continue to train the trained model with a predetermined periodicity.

In some embodiments and, optionally, in combination with any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination with any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination with any embodiment described above or below, the aggregation function may be a mathematical function that combines (e.g., sum, product, and the like) input signals to the node. In some embodiments and, optionally, in combination with any embodiment described above or below, an output of the aggregation function may be used as input to the activation function. In some embodiments and, optionally, in combination with any embodiment described above or below, the bias may be a constant value or function that may be used by the aggregation function and/or the activation function to make the node more or less likely to be activated.

According to some embodiments, when the temperature of the water in the tank 112 is determined to correspond to the temperature set point, Process 400 can proceed from Step 412 to Step 414. In Step 414, instructions can be generated that cause the heating element to be turned off, operate in standby mode and/or operate at a lower duty cycle (e.g., less power and/or less time of an applied power, which can be determined according to the processing discussed above at least in relation to Steps 404 and 412). In some embodiments, Step 414 can involve the switch (e.g., TRIAC component 204) being toggled to an alternative position so as to enable the low current values to be communicated to control board 208, as discussed above. In some embodiments, such signals can be provided via optoisolator 206, as discussed above. In such embodiments, processing of Process 400 can proceed back to Step 408 for ensure the water in tank 112 is maintained at/proximate to (according to the threshold range). In some embodiments, Step 414 can further enable the output via hot water outlet 102, as discussed above.

According to some embodiments, when the temperature of the water in the tank 112 is determined to not correspond to the temperature set point (e.g., be outside of the threshold range, for example), Process 400 can proceed from Step 412 to Step 416. In Step 416, the heating element 202 continues the heating of the water in the tank 112, and processing proceeds recursively back to Step 410 where the monitoring is continued, as discussed above.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device (e.g., UE) may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a NFC device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

For the purposes of this disclosure the term “user”. “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. An apparatus, comprising:
a water heater for a water tank;
wherein the water heater comprises:
a heating element extending into an interior of the water tank;
a body on an end of the heating element and passing through a wall of the water tank;
at least one flange on the body configured to secure the body to the water tank;
power terminals on the body on an exterior of the water tank;
at least one power line connecting the power terminals to the heating element through the body; and
at least one solid-state switch on the at least one power line in the body, wherein the at least one solid-state switch is configured to actuate power to the heating element via the at least one power line so as to achieve a temperature set point; and
a controller in communication with the solid-state switch, wherein the controller is configured to control the solid-state switch based on the temperature set point.

2. The apparatus of claim 1, further comprising:
at least one temperature sensor extending from the body into the interior of the water tank;
wherein the at least one temperature sensor is configured to measure a temperature in of water in the water tank;
wherein the at least one temperature sensor is in communication with the controller; and
wherein the controller is configured to:
determine a difference between the temperature set point and temperature of the water; and
determine the power based on the difference.

3. The apparatus of claim 1, wherein the at least one solid-state switch comprises a triode for alternating current (TRIAC).

4. The apparatus of claim 1, wherein the heating element is further associated with an optoisolator that enables connection between the heating element and controller.

5. A method comprising:
identifying, by a processor associated with an electric hot water heater (WH), a temperature set point, the temperature set point corresponding to a desired temperature of water in a tank of the electric WH;
determining, by the processor, a difference between a current temperature of the water in the tank of the electric WH and the temperature set point;
determining, by the processor, based on the determined difference, a power value to provide to a heating element of the electric WH;
enabling, by the processor, via the heating element, heating of the water in the tank of the electric WH based on the power; and
determining, by the processor, after a predetermined time of enabling the heating of the water via the heating element, whether the current temperature of the water in the tank of the electric WH corresponds, at least to a threshold range, to the temperature set point, wherein:
when the current temperature is determined to the temperature set point, toggling a solid state switch associated with the heating element, the toggling enabling communication between the solid state switch and the processor via a optoisolator, and
when the current temperature is determined to not correspond to the temperature set point, enabling continued heating of the water in the tank via the heating element.

6. The method of claim 5, wherein the solid state switch comprises a triode for alternating current (TRIAC) that is configured outside of a control board associated with the processor.

7. A non-transitory computer-readable storage medium tangibly encoded with computer-executable instructions, that when executed by a processor associated with an electric hot water heater (WH), perform a method comprising:
identifying, by the processor, a temperature set point, the temperature set point corresponding to a desired temperature of water in a tank of the electric WH;
determining, by the processor, a difference between a current temperature of the water in the tank of the electric WH and the temperature set point;
determining, by the processor, based on the determined difference, a power value to provide to a heating element of the electric WH;
enabling, by the processor, via the heating element, heating of the water in the tank of the electric WH based on the provided power; and
determining, by the processor, after a predetermined time of enabling the heating of the water via the heating element, whether the current temperature of the water in the tank of the electric WH corresponds, at least to a threshold range, to the temperature set point, wherein:
when the current temperature is determined to the temperature set point, toggling a solid state switch associated with the heating element, the toggling enabling communication between the solid state switch and the processor via a optoisolator, and
when the current temperature is determined to not correspond to the temperature set point, enabling continued heating of the water in the tank via the heating element.

8. The non-transitory computer-readable storage medium of claim 7, wherein the solid state switch comprises a triode for alternating current (TRIAC) that is configured outside of a control board associated with the processor.
